(19) United States
(12) Patent Application Publication
(10) Pub. No.: US 2020/0056975 A1
(43) Pub. Date: Feb. 20, 2020

(54) MAGNETIC INDUCTION PARTICLE DETECTION DEVICE AND CONCENTRATION DETECTION METHOD

(71) Applicant: FATRI UNITED TESTING & CONTROL (QUANZHOU) TECHNOLOGIES CO., LTD., Quanzhou, Fujian (CN)

(72) Inventors: Yongzhong NIE, Xiamen, Fujian (CN); Zhongping ZHANG, Xiamen, Fujian (CN)

(73) Assignee: FATRI UNITED TESTING & CONTROL (QUANZHOU) TECHNOLOGIES CO., LTD., Quanzhou, Fujian (CN)

(21) Appl. No.: 16/487,920

(22) PCT Filed: Nov. 30, 2018
(86) PCT No.: PCT/CN2018/118694

§ 371 Date: Aug. 22, 2019

(30) Foreign Application Priority Data
Dec. 5, 2017 (CN) 2017112684833

(51) Int. Cl. G01N 15/06

(52) U.S. Cl. CPC G01N 15/0656; G01N 2015/0053

(57) ABSTRACT

The invention provides a magnetic induction particle detection device and a concentration detection method, wherein the detection device comprises a signal detection system, a detection pipeline, excitation coil and a positive even number of induction coils, and the excitation coil are connected with the signal detection system and wound around the detection pipeline; the induction coils are connected with the signal detection system and wound around the excitation coil sequentially and reversely with respect to each other. By means of the device, preparation and installation can be facilitated, and detection precision can be improved. The method comprises the steps of: S1: acquiring an output signal of the signal detection system and obtaining a voltage amplitude change; and S2: according to the obtained voltage amplitude change, detecting the metal particle concentration. By means of the method, the precision of calculation can be improved.

### CROSS-REFERENCE TO RELATED APPLICATIONS

This application is a U.S. national phase application of International Application No. PCT/CN2018/118694, filed on Nov. 30, 2018, which claims priority to and the benefit of Chinese Patent Application No. 201711268483.3, filed on Dec. 5, 2017. The disclosures of the above applications are incorporated herein by reference.

### FIELD

The present disclosure relates to the field of detection equipment, in particular to a magnetic induction particle detection device, and further relates to a method for detecting concentration by using the device.

### BACKGROUND

The statements in this section merely provide background information related to the present disclosure and may not constitute prior art.

At present, a plurality of methods have been adopted for detecting metal particles, wherein the method for detecting metal particles by using the electromagnetic induction principle is a more typical method. Specifically, a typical device for detecting metal particles by applying electromagnetic induction usually adopts two reversely wound excitation coils as excitation sources to generate two magnetic fields with the same strength and opposite directions, and under the condition of no magnetic field disturbance, the net magnetic field between the two coils is zero; an induction coil for responding to magnetic field change is wound in therebetween and used for responding to magnetic field disturbance caused by metal particles.

Although this device enables electromagnetic detection of metal particles, the device still suffers from the following defects:

(1) In order to establish magnetic field balance and induce magnetic field signals of metal particles, two reverse excitation coils and one induction coil are needed, but such a configuration results in longer length of the sensor, being disadvantageous to actual design, preparation, installation and use;

(2) Only one magnetic induction coil is adopted, when electromagnetic induction is applied for establishing magnetic field balance, the attenuation of the magnetic field outside the excitation coil (magnet excitation coil) is obvious, the magnetic field disturbance generated by small particles on the excitation coil is often attenuated greatly when showing on the external induction coil, consequently the detection accuracy of the small particles is insufficient, which affects the detection.

Furthermore, the detection method by using the data measured by the device of the prior art is correspondingly poor in accuracy, thus it's difficult to accurately detect the concentration of the metal particles in the fluid.

### SUMMARY

In order to overcome the defects of the prior art, the first technical object of the invention is to provide a magnetic induction particle detection device which can be conveniently prepared and installed and can improve the detection accuracy, and the second technical object of the invention is to provide a method for detecting the concentration of metal particles by using the detection device.

In order to achieve the first technical object, the technical solution adopted by the invention is specifically as follows:

A magnetic induction particle detection device, said detection device comprising a signal detection system, a detection pipeline, an excitation coil and a positive even number of induction coils, wherein the excitation coil is connected with the signal detection system and wound around the detection pipeline; the induction coils are connected with the signal detection system and wound around the excitation coil sequentially and reversely with respect to each other.

Generally, in the technical solution of the existing device for detecting particles through electromagnetic induction, two reverse excitation coils that are wound at both ends of the pipeline reversely with respect to each other and externally to the pipeline and one induction coil that is wound between the two excitation coils are required for installation. However, in the present technical solution, the arrangement that the induction coil is wound externally to the excitation coil of the device can achieve the effects that the installation is facilitated, the overall length of the sensor is greatly shortened, and the device is convenient to prepare and use.

The excitation coil is connected with the signal detection system, and the signal detection system inputs a sinusoidal alternating signal at both ends of the excitation coil to generate an alternating magnetic field and drive the induction coil. In addition, with the induction coil wound around the detection pipeline, the condition of particles can be detected without contacting the sensor directly with liquid in the pipeline, which facilitates the detection.

In order to achieve an improved detection accuracy, the inventor adopts a positive even number of magnetic induction coils in the solution of the invention. Generally, in the prior art, only one magnetic induction coil is wound, which seemingly saves the costs, but in fact renders an insufficient accuracy of the size of the induced particles, because the induction coil is positioned between the two excitation coils to respond to the magnetic field disturbance generated by the induction particles through the excitation coil, but the induction coil is far away from the excitation coil, always resulting in a great magnetic field attenuation.

However, in the present technical solution, the excitation coil is adopted and a positive even number of induction coils are used for winding on the excitation coil so as to ensure the detection accuracy. The excitation coil is used to generate a magnetic field and therefore preferably one excitation coil is used for winding. The use of an even positive number of induction coils, such as two or a group of induction coils, can be adapted to the algorithm set by the inventor to calculate the concentration of metal particles by observing and inputting changes in the magnetic field obtained by the two induction coils.

The induction coils are sequentially wound around the excitation coil. In this arrangement, magnetic field disturbance generated when particles pass through the induction coils can be quickly detected, so as to achieve the detection of metal particles.

The induction coils are wound reversely with each other on the excitation coil. Due to the proximity of the induction coils, the environment of the induction coils can be considered to be consistent, temperature drift and electromagnetic interference can be restrained in a complex and severe environment, and thus signal stability is enhanced and system performance is further improved.

It should be noted that a coil refers to a length of coil connected at both ends to the signal detection system and wound around the detection pipeline.

It should be noted that winding sequentially means, for example, after completion of winding one of the two induction coils, winding the other induction coil in the direction of the detection pipeline from the next position in this direction, i.e., one induction coil does not coincide with the other, but independently wound around the pipeline.

It should be noted that winding reversely means that the two induction coils do not coincide with each other while being wound externally to the excitation coil, one in the clockwise direction and the other in the counterclockwise direction. It should be noted that the detection of particles, as used herein, refers to the detection of, for example, metal particles by means of electromagnetic induction, specially of the flow thereof, so as to facilitate the further analysis of the concentration of metal particles matter in a liquid, and the like.

It should be noted that the signal detection system detects electromagnetic induction conditions, and in an alternative embodiment, includes a control circuit board, a signal output port, etc. It should not be limited to the manner in which a signal detection system is constructed, any mechanism capable of detecting the electromagnetic change of the induction coils is supposed to be the signal detection system.

It should be noted that two adjacent, sequentially and reverse wound, and corresponding induction coils are a set of induction coils.

Preferably, the number of induction coils is two, four or six.

In order to optimally balance the installation and manufacturing costs and the detection accuracy, it would be preferable to set the number of the induction coils as two.

Alternatively, the number of the induction coils is set as four, six or the like, multiple times of measurement and averaging can be carried out in the measurement process to improve the reliability of detection.

Preferably, the excitation coils are two or more, and are wound around the detection pipeline in the same direction.

It should be noted that winding in the same direction means that each excitation coil is wound clockwise or counterclockwise around the detection pipeline. This arrangement can increase the magnetic field strength, and meanwhile the mutual interference among the excitation coil can be prevented and the stability of the magnetic field can be free from influence.

Preferably, the excitation coil and/or the induction coils are wound in at least one layer.

The excitation coil and/or the induction coils are wound in at least one layer (i.e., multiple layers), so that the strength of the magnetic field generated by the excitation coil can be further increased, signals generated on the induction coil are more obvious, and the detection accuracy of the metal particles is improved.

Preferably, the detection pipeline is made of a non-magnetic conductive material; further preferably, the detection pipeline is made of stainless steel.

The detection pipeline is made of a non-magnetic conductive material so as to measure the magnetic field disturbance generated by metal particles on the excitation coil more accurately. In the testing process, it's necessary to try to ensure that the magnetic field generated by the excitation coil passes through the pipeline to improve the magnetic field strength therein. More preferably, a non-magnetic conductive stainless steel material is used, which meets the requirement but does not exclude other materials.

Preferably, a spacer ring sleeve is further arranged between the excitation coil and the induction coils; further preferably, the spacer ring sleeve is made of a non-magnetic conductive material.

A spacer ring sleeve is additionally arranged between the excitation coil and the induction coils and used for isolating the excitation coil and the induction coils. The non-magnetic conductive material herein is mainly used for isolating the excitation coil and the induction coils during winding in the production and manufacturing process, because trying to reduce the magnetic field loss between the induction coils and the excitation coil in the process of responding to the magnetic field disturbance generated by the metal particles is advantageous for improving the detection accuracy of metal particles; meanwhile, as a frame around which the induction coils are wound, the spacer ring sleeve can improve the flatness during winding the induction coils.

Preferably, a shielding ring is arranged outside the induction coils.

Due to the fact that the shielding ring is arranged outside the induction coil, the external magnetic field can be isolated, and the interference of the external magnetic field is prevented, rendering a more accurate detection result and a better detection effect.

In order to achieve the second technical object, the technical solution adopted by the invention is specifically as follows:

A concentration detection method applying the magnetic induction particle detection device, comprising the steps of:

S1: acquiring an output signal of the signal detection system to obtain a voltage amplitude change;

S2: detecting the metal particle concentration according to the obtained voltage amplitude change;

wherein the voltage amplitude change comprises changes of voltage amplitude and time, i.e. the relationship between the voltage amplitude change and the time, such as the voltage amplitude at a certain time. More specifically, the relationship may refer to the time corresponding to the voltage amplitude at the highest point or the voltage amplitude being zero.

Preferably, detecting the metal particle concentration comprises the steps of:

obtaining the flow velocity v of the metal particles passing through the induction coils;

obtaining the mass m of the metal particles; and

calculating the concentration of the particles c on the basis of the flow velocity v of the metal particles, the mass m of the metal particles, the elapsed time t and the cross-sectional area S of the pipeline by using the following formula:

$$c = \frac{m}{v \times t \times S}$$

During the process of obtaining the mass of the metal particles m, in the single-layer densely wound coil, the induction voltage E caused when the metal particles pass through the spiral coil induction coil is directly proportional to the volume V, the magnetic conductivity, the passing speed of the particles v, and the third power of the winding density of the coil. Through quantitative analysis on the output signal of the sensor, the volume and the mass of the metal particles flowing through the lubricating oil pipeline can be calculated through conversion.

It should be noted that the elapsed time t refers to the time required for the passage of the metal particles in the pipeline over a certain distance, which may correspond to the elapsed time between different amplitudes, or to the difference between the times of different amplitudes.

Preferably, the method of obtaining the metal particle flow velocity v comprises the steps of:

Respectively recording the times when the voltage amplitude of the metal particles passing through a group of induction coils measured by the signal detection system is at the highest point and at the zero point during the positive half cycle, and calculating the time difference value ΔT₁ and the length L₁ of the corresponding induction coils; respectively recording the times when the voltage amplitude, measured by the signal detection system, is at the zero point and at the highest point during the negative half cycle, and calculating the time difference value ΔT₂ and the length L₂ of the corresponding induction coils; and

Obtaining the flow velocity according to this formula:

$$v = \frac{\frac{{k}_{1} \times {L}_{1}}{Δ {T}_{1}} + \frac{{k}_{2} \times {L}_{2}}{Δ {T}_{2}}}{2}$$

It should be noted that L₁ refers to the length of the induction coils during the passage starting with the voltage amplitude at the highest point and ending with the voltage amplitude at the zero point during the positive half cycle; L₂ refers to the length of the induction coils during the passage starting with the voltage amplitude at the zero point and ending with the voltage amplitude at the highest point during the negative half cycle.

The coefficient k₁ refers to a correction coefficient when passing through a coil; and the coefficient k₂ refers to the correction coefficient when passing the other coil.

Because different factors such as the wire (thickness and/or material) of each lubricating oil sensor, the number of winding turns and the interaction between the two induction coils affect the output signal, making the sensor fail to sense the middle of the induction coils, the correction coefficient k₁ or k₂ is introduced to correct the output signal.

More specifically, when ferromagnetic particles pass through the two induction coils, they sequentially pass through the induction coil 1 and the induction coil 2, and during the passage through the induction coil 1, if the influence of the induction coil 2 on the induction coil 1 is not considered, the highest point of the output signal may occur in the middle of the induction coil 1, but with the induction coil 2 introduced, the magnetic field generated by the induction coil 2 may influence where the highest point of the output signal occurs, resulting in a slight offset.

Preferably, if there are multiple groups of induction coils, the flow velocity v of the metal particles passing through the induction coils is the average value of the flow velocities of particles passing through each group of induction coils.

For example, in S1, the flow velocity vgn (wherein n is a positive integer) of the metal particles passing through the gnth group of induction coils is respectively calculated, and the flow velocity v is the average value of the flow velocities of particles passing through each group of induction coils, namely:

$$v = \frac{{v}_{g 1} + {v}_{g 2} + … + {v}_{gn}}{n}$$

The calculation accuracy of the flow velocity can be improved by calculating an average value, and hence the calculation result is more accurate.

Preferably, the frequency at which the output signal of the signal detection system is acquired in S1 is once per microsecond.

The method has the following beneficial effect due to the acquisition frequency of once per millisecond: the frequency of the output signal is 500 Hz, according to the sampling theorem, the sampling frequency should be more than twice of the highest frequency of the signal, such that the complete information of the signal can be preserved lossless without distortion, therefore, the sampling frequency of 1K, namely, 1,000 effective signals are sampled every second (once per millisecond) for analysis.

Compared with the prior art, the magnetic induction particle detection device has the advantages as follows:

1. The induction coil of the device is wound outside the excitation coil, so that the installation is convenient, the whole length of the sensor is greatly shortened, and prepare and use of the device are facilitated;

2. The induction coil of the device is wound around the detection pipeline, so that measurement of particles can be detected without contacting the sensor directly with liquid in the pipeline, so that the test is more convenient;

3. According to the device, at least two induction coils are adopted for winding around the excitation coil to ensure the detection accuracy;

4. According to the device, a spacer ring sleeve is additionally arranged between the excitation coil and the induction coils and is used for isolating the excitation coil and the induction coils, so that the magnetic field loss between the induction coils and the excitation coil is reduced; meanwhile, as a frame around which the induction coils are wound, the spacer ring sleeve can improve the flatness during winding the induction coils;

5. According to the device, a shielding ring is arranged outside the induction coils, so that an external magnetic field can be isolated, the interference of the external magnetic field is prevented, rendering a more accurate detection result and a better detection effect.

The above description is merely a summary of the technical solutions of the present invention, in order to render a more clear understanding of the technical means of the present invention to implement according to the content of the description, and in order to render the above and other objects, features and advantages of the present invention to be more readily understood, the following detailed description of the preferred embodiments is carried out taken in conjunction with the accompanying drawings.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic cross-sectional view of a first preferred embodiment of the magnetic induction particle detection device of the present invention;

FIG. 2 is a schematic cross-sectional view of a second preferred embodiment of the magnetic induction particle detection device of the present invention;

FIG. 3 is a partially enlarged schematic view of area A in FIG. 2;

FIG. 4 is a schematic diagram showing the principle of electromagnetic induction test performed by the magnetic induction particle detection device of the present invention;

FIG. 5 is a graph of voltage output change corresponding to the schematic diagram of mechanism of FIG. 4.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In order to further illustrate the technical means of the present invention for achieving the intended purposes thereof as well as effects, the following detailed description is made, taken in conjunction with the accompanying drawings and preferred embodiments, to illustrate specific embodiments, structures, features and efficacy thereof according to the present invention.

### Embodiment 1 (Magnetic Induction Particle Detection Device)

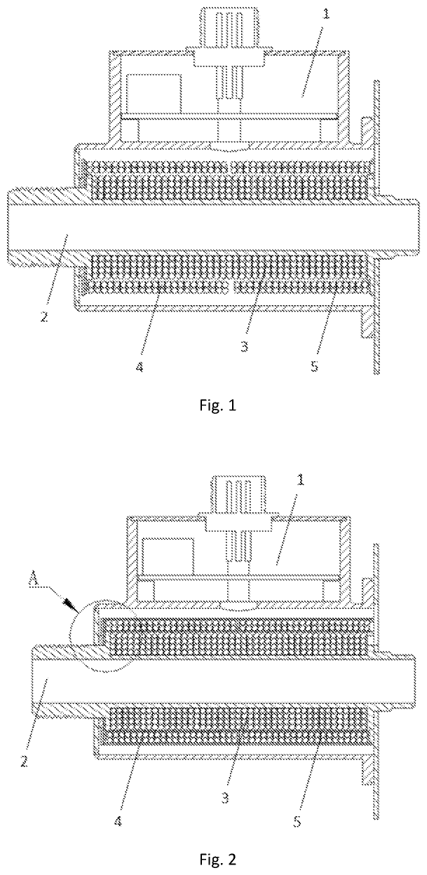

FIG. 1 is a schematic cross-sectional view of a first preferred embodiment of the magnetic induction particle detection device of the present invention; the detection device comprises a signal detection system 1, a detection pipeline 2, an excitation coil 3 and two induction coils (a first induction coil 4 and a second induction coil 5 respectively), wherein the excitation coil is connected with the signal detection system and wound around the detection pipeline; the induction coils are connected with the signal detection system and wound around the excitation coil sequentially and reversely with respect to each other.

The above is one of the preferred embodiments of the present technical solution. This embodiment has the following beneficial effects:

(1) According to the device, the induction coil is wound outside the excitation coil, so that the installation is convenient, the whole length of the sensor is greatly shortened, and prepare and use of the device are facilitated;

(2) The induction coil of the device is wound around the detection pipeline, so that measurement of particles can be detected, without contacting the sensor directly with liquid in the pipeline, so that the test is more convenient;

(3) The induction coils are sequentially wound around the excitation coil, so that the magnetic field disturbance generated when particles pass through the induction coils can be quickly detected, so as to achieve the detection of metal particles;

(4) The induction coils are wound reversely with each other on the excitation coil; due to the proximity of the induction coils, the environment of the induction coils can be considered to be consistent, temperature drift and electromagnetic interference can be restrained in a complex and severe environment, and thus signal stability is enhanced and system performance is further improved.

In this embodiment, there is one excitation coil for generating a magnetic field. In other embodiments, the number of the excitation coil may be two or more, but co-directional winding is required to prevent mutual interference of the magnetic fields and influence on the measurement effect.

In this embodiment, there are two induction coils. This arrangement can effectively improve the detection accuracy and ensure a better detection effect. Or in other embodiments, the number of the induction coils is a positive even number, such as four, six or more, on the one hand, the same detection effect can be achieved, and on the other hand, the detection reliability can be improved by averaging multiple measurements.

In this embodiment, the material of the detection pipeline is made of a non-magnetic conductive material; further preferably, the detection pipeline is made of stainless steel. The detection pipeline is made of a non-magnetic conductive material so as to measure the magnetic field disturbance generated by metal particles on the excitation coil more accurately. In the testing process, it's necessary to try to ensure that the magnetic field generated by the excitation coil pass through the pipeline to improve the magnetic field strength therein. More preferably, a non-magnetic conductive stainless steel material is used, which meets the requirement but does not exclude other materials.

### Embodiment 2 (Magnetic Induction Particle Detection Device)

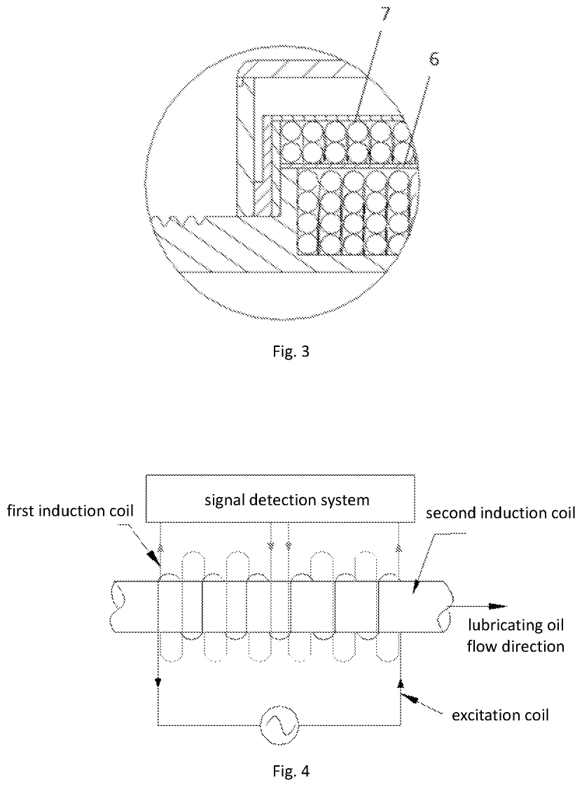

FIG. 2 is a schematic view showing the structure of a second preferred embodiment of the magnetic induction particle detection device of the present invention; this embodiment differs from the above-mentioned embodiment 1 in that: as shown in FIG. 3, a spacer ring sleeve 6 is further arranged between the excitation coil and the induction coils in the detection device, that is, the excitation coil is sleeved with a spacer ring sleeve, and the induction coils are wound around the spacer ring sleeve. And a shielding ring 7 is arranged outside the induction coil.

Both or one of the above technical solutions can be implemented as required. In this embodiment, both solutions are implemented, that is, a spacer ring sleeve and a shielding ring are arranged, which is a more preferred embodiment.

The arrangement of the spacer ring sleeve, on one hand, is mainly used for isolating the excitation coil and the induction coils during winding in the production and manufacturing process, and on the other hand, the spacer ring sleeve can be used meanwhile as a frame around which the induction coils are wound, thus the flatness of the induction coil winding can be improved. Further preferably, the spacer ring sleeve is made of a non-magnetic conductive material, the magnetic field loss between the induction coils and the excitation coil is minimized as much as possible in the process of responding to the magnetic field disturbance generated by the metal particles, which is advantageous to improving the detection accuracy of the metal particles, and therefore the non-magnetic conductive material is selected herein.

The arrangement of the shielding ring outside the induction coil can isolate the external magnetic field, prevent the interference of the external magnetic field, thus rendering a more accurate detection result and a better detection effect.

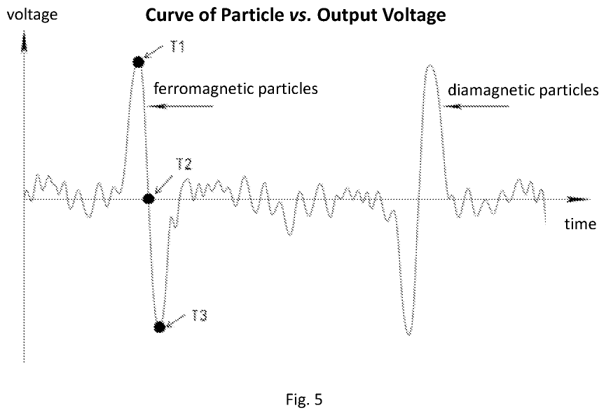

With reference to FIGS. 4 and 5, taking the arrangement in the above-described embodiment as an example, the implementation principle of the device will be described hereinafter as follows:

An alternating magnetic field can be generated by inputting a sinusoidal alternating signal at two ends of the excitation coil; under the action of an alternating magnetic field, alternating signals can be generated at two ends of the induction coil.

Depending on the magnetic conductivity of the material, metal materials can be roughly classified as diamagnetic (<1), paramagnetic (>1), and ferromagnetic (>>1). The diamagnetic material weakens the magnetic field, the paramagnetic material strengthens the magnetic field, and the ferromagnetic material greatly increases the magnetic field strength. In a circuit, opposite output ends of the two induction coils are connected, and output signals of the other two ends are measured. When no metal particles pass through the interior of the excitation coil, induction signals of the two induction coils cancel out each other, thus the overall output of the system is zero. When metal particles (ferromagnetic materials) pass through the interior of the excitation coil from left to right, the process is divided into the following stages:

(1) When the metal particles enter the first induction coil, the change of the first induction coil is relatively sensitive, and firstly the voltage value rises, but the change of the second induction coil is relatively slow, therefore, at the moment, the two ends of the induction coil output a rising positive voltage;

(2) Along with the metal particles approaching the middle, the second induction coil is also influenced, at the moment, the voltage generated by the first induction coil is slowly balanced by the voltage generated by the second induction coil and gradually decreases, and then decreases to zero in the middle of the first induction coil and the second induction coil;

(3) The metal particles pass through the first induction coil and enter the second induction coil, at the moment, the voltage value of the second induction coil is higher than that of the first induction coil, a negative voltage appears, and the voltage amplitude is continuously increasing;

(4) When the particles pass through the second induction coil and flow out of the second induction coil, the influence on the second induction coil is slowly weakened, the voltage amplitude is slowly decreasing and then approaches zero when the particles leave the second induction coil behind for a certain distance.

According to the electromagnetic induction principle, when metal particles pass through the lubricating oil pipeline from left to right, the sensor equipment can detect a signal similar to a sinusoidal wave, the amplitude of the signal is proportional to the size of the particles, and the period of the signal is proportional to the flow velocity of the particles, on such a basis, the flow velocity is calculated.

### Embodiment 3 (Concentration Detection Method Applying the Magnetic Induction Particle Detection Device)

This embodiment provides a detection method applying the magnetic induction particle detection device mentioned above, comprising the steps of:

S1: acquiring an output signal of the signal detection system to obtain a voltage amplitude change;

S2: detecting the metal particle concentration according to the obtained voltage amplitude change;

Wherein the voltage amplitude change comprises changes of voltage amplitude and time, namely the relationship between the voltage amplitude change and the time, such as the voltage amplitude at a certain time.

In a preferred embodiment, detecting the metal particle concentration comprises the steps of:

obtaining the flow velocity v of the metal particles passing through the induction coils;

obtaining the mass m of the metal particles; and

calculating the concentration of the particles c on the basis of the flow velocity v of the metal particles, the mass m of the metal particles, the elapsed time t and the cross-sectional area S of the pipeline by using the following formula:

$$c = \frac{m}{v \times t \times S}$$

In a more preferred embodiment, the method of obtaining the metal particle flow velocity v comprises the steps of:

Respectively recording the times when the voltage amplitude of the metal particles passing through a group of induction coils measured by the signal detection system is at the highest point and at the zero point during the positive half cycle, and calculating the time difference value ΔT₁ and the length L₁ of the corresponding induction coils; respectively recording the times when the voltage amplitude, measured by the signal detection system, is at the zero point and at the highest point during the negative half cycle, and calculating the time difference value ΔT₂ and the length L₂ of the corresponding induction coils; and

Obtaining the flow velocity according to this formula:

$$v = \frac{\frac{{k}_{1} \times {L}_{1}}{Δ {T}_{1}} + \frac{{k}_{2} \times {L}_{2}}{Δ {T}_{2}}}{2}$$

Due to the fact that detection points at zero points are too many in the output signal, errors are likely to be caused in an actual sampling process; therefore, in this method, the highest points of the positive half cycle and the negative half cycle of the signal is selected as a time recording point to be used for flow velocity analysis.

In the process that particles flow through the lubricating oil pipeline, the length of the pipeline L is certain, T₁, T₂ and T₃ are sampled, wherein T₁ is the moment when a signal goes by the highest point of the positive half cycle, T₂ is the moment when the signal goes by the zero point, and T₃ is the moment when the signal goes by the highest point of the negative half cycle, as shown in FIG. 5; the flow velocity can be obtained by time sampling:

$$v = K \times \frac{L}{Δ T}$$

Because different factors, such as the wire (thickness, material) of each lubricating oil sensor, the number of winding turns and the interaction between the two induction coils affect the output signal, making the sensor fail to sense the middle of the induction coils, the correction coefficient K is introduced to correct the output signal. Meanwhile, analysis is carried out on the basis of two time periods, namely, T₁ to T₂ and T₂ to T₃, and the average flow velocity is taken to reduce errors.

$${v}_{1} = K \times \frac{L}{2 \times ( {T}_{2} - {T}_{1} )}$$

$${v}_{2} = K \times \frac{L}{2 \times ( {T}_{3} - {T}_{2} )}$$

$$v = \frac{{v}_{1} + {v}_{2}}{2}$$

Wherein L is the total length through the induction coil, and L/2 is the coil length through two half cycles respectively.

The above is the calculated velocity of particles passing through one set of induction coils.

In the output signal, the amplitude of the signal is related to the size of the metal particles. When the cylindrical metal particles pass through the interior of the spiral pipe at a constant speed, the induced electromotive force is calculated as follows:

E=−4kμ₀μᵣn³VI₀v

Wherein k is a system correction coefficient, n is the density of a coil, i.e., turn number (winding turns per unit length=total turns/total length), V is a particle volume, and v is a particle flow velocity.

In a single-layer densely wound coil, the induction voltage E caused when the metal particles pass through the spiral coil induction coil is directly proportional to the volume V, the magnetic conductivity, the passing speed of the particles v, and the third power of the winding density of the coil. Through quantitative analysis on the output signal of the sensor, the volume and the mass of the metal particles flowing through the lubricating oil pipeline can be calculated through conversion. Under the condition that the lubricating oil flow velocity v is obtained, the concentration of metal particles is measured, and the method is as follows:

With the cross-sectional area S of the pipeline given, by converting the number and size of passing metal particles obtained on the basis of the amplitude value of the output signal in a period t into the total mass m, the concentration of the metal particles is obtained through the following formula:

$$c = \frac{m}{v \times t \times S} ( µ g \text{/} {m}^{3} )$$

In a further preferred embodiment, the frequency at which the output signal of the signal detection system is acquired in S1 is once per millisecond.

### Embodiment 4 (Concentration Detection Method Applying the Magnetic Induction Particle Detection Device)

This embodiment differs from the embodiment 3 in that calculation of the flow velocity of this embodiment adopts a more preferred embodiment, that is, if there are multiple groups of induction coils, the flow velocity v at which the metal particles pass through the induction coils is an average value of the flow velocities of all the groups of induction coils.

For example, the flow velocity vgn (wherein n is a positive integer) of the metal particles passing through the nth group of induction coils is respectively calculated in the S1, and the flow velocity v is the average value of the flow velocities of all the groups of induction coils, namely:

$$v = \frac{{v}_{g 1} + {v}_{g 2} + … + {v}_{gn}}{n}$$

The calculation accuracy of the flow velocity can be improved by an averaging method, and the detection result is more accurate.

For example, in the device, there are two groups of induction coils in total, the flow velocity measured for the first group of induction coils is vg1, the flow velocity measured for the second group of induction coils is vg2, and then the flow velocity finally calculated in S1 can be obtained by the following formula:

$$v = \frac{{v}_{g 1} + {v}_{g 2}}{2}$$

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The above-described embodiments are merely preferred embodiments of the present invention, and thus do not limit the scope of the present invention, and any insubstantial changes and substitutions made by those skilled in the art on the basis of the present invention are intended to be within the scope of the present invention.

1. A magnetic induction particle detection device, comprising:
a signal detection system;
a detection pipeline;
an excitation coil; and
a positive even number of induction coils,
wherein the excitation coil is connected with the signal detection system and wound around the detection pipeline, and the induction coils are connected with the signal detection system and wound around the excitation coil sequentially and reversely with respect to each other.

2. The magnetic induction particle detection device according to claim 1, wherein the excitation coils are two or more, and each of the excitation coils are wound around the detection pipeline in same direction.

3. The magnetic induction particle detection device according to claim 1, wherein the excitation coil and/or the induction coils are wound in at least one layer.

4. The magnetic induction particle detection device claim 1, wherein the detection pipeline is made of a non-magnetic conductive material.

5. The magnetic induction particle detection device according to claim 1, wherein a spacer ring sleeve is further arranged between the excitation coil and the induction coils.

6. The magnetic induction particle detection device according to claim 1, wherein a shielding ring is arranged outside the induction coils.

7. A concentration detection method applying the magnetic induction particle detection device according to claim 1, wherein the method comprises steps of:
S1: acquiring an output signal of the signal detection system to obtain a voltage amplitude change;
S2: detecting a metal particle concentration according to the obtained voltage amplitude change.

8. The concentration detection method according to claim 7, wherein said obtaining the flow velocity v of the metal particles comprises steps of:
respectively recording time when voltage amplitude of the metal particles passing through a group of the induction coils measured by the signal detection system is at highest point and at zero point during positive half cycle, and calculating time difference value ΔT₁ and length L₁ of the corresponding induction coils; respectively recording time when voltage amplitude, measured by the signal detection system, is at zero point and at highest point during negative half cycle, and calculating time difference value ΔT₂ and length L₂ of the corresponding induction coils; and
obtaining the flow velocity according to formula:
$$v = \frac{\frac{{k}_{1} \times {L}_{1}}{Δ {T}_{1}} + \frac{{k}_{2} \times {L}_{2}}{Δ {T}_{2}}}{2}$$

9. The concentration detection method according to claim 7, wherein if there are multiple groups of the induction coils, the flow velocity v of the metal particles passing through the induction coils is an average value of flow velocities of the particles passing through each said group of induction coils.

10. The concentration detection method according to claim 7, wherein a frequency at which the output signal of the signal detection system is acquired in S1 is once per millisecond.

11. The magnetic induction particle detection device according to claim 1, wherein the number of the induction coils is two or four or six.

12. The magnetic induction particle detection device according to claim 4, wherein the detection pipeline is made of stainless steel.

13. The magnetic induction particle detection device according to claim 5, wherein the spacer ring sleeve is made of a non-magnetic conductive material.

14. The concentration detection method according to claim 7, wherein said detecting said metal particle concentration comprises the steps of:
obtaining flow velocity v of metal particles passing through the induction coils;
obtaining mass m of the metal particles; and
calculating concentration of the particles c on the basis of the flow velocity v of the metal particles, the mass m of the metal particles, elapsed time t and cross-sectional area S of the detection pipeline by using following formula:
$$c = \frac{m}{v \times t \times S}$$
